(19) United States
(12) Patent Application Publication
(10) Pub. No.: US 2024/0340856 A1
(43) Pub. Date: Oct. 10, 2024

(54) TRANSMIT POWER AND BEAM SELECTION FOR RANDOM ACCESS CHANNEL PROCEDURE MESSAGES

(71) Applicant: QUALCOMM Incorporated, San Diego, CA (US)

(72) Inventors: Tianyang BAI, Mountain View, CA (US); Yan ZHOU, San Diego, CA (US); Jelena DAMNJANOVIC, Del Mar, CA (US); Junyi LI, Fairless Hills, PA (US)

(21) Appl. No.: 18/440,165

(22) Filed: Feb. 13, 2024

Related U.S. Application Data
(60) Provisional application No. 63/494,944, filed on Apr. 7, 2023.

(51) Int. Cl. H04W 72/02; H04L 5/00; H04W 72/044; H04W 72/232; H04W 74/0833

(52) U.S. Cl. CPC H04W 72/02; H04L 5/0035; H04W 72/232; H04W 74/0833; H04W 72/046

(57) ABSTRACT

Various aspects of the present disclosure generally relate to wireless communication. In some aspects, a user equipment (UE) may receive a physical downlink control channel (PDCCH) order downlink control information (DCI) that is for transmission of a physical random access channel (PRACH) message to a candidate cell. The UE may transmit the PRACH message with a transmit power that is based at least in part on whether the PDCCH order DCI applies to an initial transmission or a retransmission. Numerous other aspects are described.

### CROSS-REFERENCE TO RELATED APPLICATION

This patent application claims priority to U.S. Provisional Patent Application No. 63/494,944, filed on Apr. 7, 2023, entitled “TRANSMIT POWER AND BEAM SELECTION FOR RANDOM ACCESS CHANNEL PROCEDURE MESSAGES,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for selecting a transmit power or a beam for random access channel procedure messages.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a physical downlink control channel (PDCCH) order downlink control information (DCI) that is for transmission of a physical random access channel (PRACH) message to a candidate cell. The method may include transmitting the PRACH message with a transmit power that is based at least in part on whether the PDCCH order DCI applies to an initial transmission or a retransmission.

Some aspects described herein relate to a method of wireless communication performed by a UE. The method may include transmitting a random access channel (RACH) message to a candidate cell based at least in part on receiving a PDCCH order DCI from a serving cell. The method may include selecting a beam to receive a random access response (RAR). The method may include receiving the RAR using the beam.

Some aspects described herein relate to a method of wireless communication performed by a UE. The method may include triggering a first RACH procedure for Layer 1 or Layer 2 triggered mobility (LTM). The method may include triggering a second RACH procedure. The method may include transmitting a PRACH message for the first RACH procedure or the second RACH procedure based at least in part on a prioritization rule or condition.

Some aspects described herein relate to a method of wireless communication performed by a UE. The method may include receiving a component carrier (CC) configuration for one or more CC lists that each include at least one multiple transmit receive point (mTRP) CC and at least one single TRP (STRP) CC. The method may include receiving a transmission configuration indicator (TCI) state configuration for a CC in a CC list of the one or more CC lists. The method may include applying the TCI state configuration to all CCs in the CC list.

Some aspects described herein relate to a UE for wireless communication. The UE may include memory and one or more processors coupled to the memory. The one or more processors may be configured to receive a PDCCH order DCI that is for transmission of a PRACH message to a candidate cell. The one or more processors may be configured to transmit the PRACH message with a transmit power that is based at least in part on whether the PDCCH order DCI applies to an initial transmission or a retransmission.

Some aspects described herein relate to a UE for wireless communication. The UE may include memory and one or more processors coupled to the memory. The one or more processors may be configured to transmit a RACH message to a candidate cell based at least in part on receiving a PDCCH order DCI from a serving cell. The one or more processors may be configured to select a beam to receive an RAR. The one or more processors may be configured to receive the RAR using the beam.

Some aspects described herein relate to a UE for wireless communication. The UE may include memory and one or more processors coupled to the memory. The one or more processors may be configured to trigger a first RACH procedure for LTM. The one or more processors may be configured to trigger a second RACH procedure. The one or more processors may be configured to transmit a PRACH message for the first RACH procedure or the second RACH procedure based at least in part on a prioritization rule or condition.

Some aspects described herein relate to a UE for wireless communication. The UE may include memory and one or more processors coupled to the memory. The one or more processors may be configured to receive a CC configuration for one or more CC lists that each include at least one mTRP CC and at least one sTRP CC. The one or more processors may be configured to receive a transmission configuration indicator (TCI) state configuration for a CC in a CC list of the one or more CC lists. The one or more processors may be configured to apply the TCI state configuration to all CCs in the CC list.

Some aspects described herein relate to a non-transitory computer-readable medium that stores a set of instructions for wireless communication by a UE. The set of instructions, when executed by one or more processors of the UE, may cause the UE to receive a PDCCH order DCI that is for transmission of a PRACH message to a candidate cell. The set of instructions, when executed by one or more processors of the UE, may cause the UE to transmit the PRACH message with a transmit power that is based at least in part on whether the PDCCH order DCI applies to an initial transmission or a retransmission.

Some aspects described herein relate to a non-transitory computer-readable medium that stores a set of instructions for wireless communication by a UE. The set of instructions, when executed by one or more processors of the UE, may cause UE to transmit a RACH message to a candidate cell based at least in part on receiving a PDCCH order DCI from a serving cell. The set of instructions, when executed by one or more processors of the UE, may cause UE to select a beam to receive an RAR. The set of instructions, when executed by one or more processors of the UE, may cause UE to receive the RAR using the beam.

Some aspects described herein relate to a non-transitory computer-readable medium that stores a set of instructions for wireless communication by a UE. The set of instructions, when executed by one or more processors of the UE, may cause UE to trigger a first RACH procedure for LTM. The set of instructions, when executed by one or more processors of the UE, may cause UE to trigger a second RACH procedure. The set of instructions, when executed by one or more processors of the UE, may cause UE to transmit a PRACH message for the first RACH procedure or the second RACH procedure based at least in part on a prioritization rule or condition.

Some aspects described herein relate to a non-transitory computer-readable medium that stores a set of instructions for wireless communication by a UE. The set of instructions, when executed by one or more processors of the UE, may cause UE to receive a CC configuration for one or more CC lists that each include at least one mTRP CC and at least one sTRP CC. The set of instructions, when executed by one or more processors of the UE, may cause UE to receive a TCI state configuration for a CC in a CC list of the one or more CC lists. The set of instructions, when executed by one or more processors of the UE, may cause UE to apply the TCI state configuration to all CCs in the CC list.

Some aspects described herein relate to an apparatus for wireless communication. The apparatus may include means for receiving a PDCCH order DCI that is for transmission of a PRACH message to a candidate cell. The apparatus may include means for transmitting the PRACH message with a transmit power that is based at least in part on whether the PDCCH order DCI applies to an initial transmission or a retransmission.

Some aspects described herein relate to an apparatus for wireless communication. The apparatus may include means for transmitting a RACH message to a candidate cell based at least in part on receiving a PDCCH order DCI from a serving cell. The apparatus may include means for selecting a beam to receive an RAR. The apparatus may include means for receiving the RAR using the beam.

Some aspects described herein relate to an apparatus for wireless communication. The apparatus may include means for triggering a first RACH procedure for LTM. The apparatus may include means for triggering a second RACH procedure. The apparatus may include means for transmitting a PRACH message for the first RACH procedure or the second RACH procedure based at least in part on a prioritization rule or condition.

Some aspects described herein relate to an apparatus for wireless communication. The apparatus may include means for receiving a CC configuration for one or more CC lists that each include at least one mTRP CC and at least one sTRP CC. The apparatus may include means for receiving a TCI state configuration for a CC in a CC list of the one or more CC lists. The apparatus may include means for applying the TCI state configuration to all CCs in the CC list.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a four-step random access procedure, in accordance with the present disclosure.

FIG. 5 is a diagram illustrating an example of physical downlink control channel order downlink control information, in accordance with the present disclosure.

FIG. 6 is a diagram illustrating an example of random access responses (RARs), in accordance with the present disclosure.

FIG. 7 is a diagram illustrating an example of RARs, in accordance with the present disclosure.

FIG. 8 is a diagram illustrating examples of medium access control control element (MAC CE) formats for RAR, in accordance with the present disclosure.

FIG. 9 is a diagram illustrating an example of random access channel prioritization, in accordance with the present disclosure.

FIG. 10 is a diagram illustrating an example of component carrier lists, in accordance with the present disclosure.

FIG. 11 is a diagram illustrating an example process performed, for example, by a UE, in accordance with the present disclosure.

FIG. 12 is a diagram illustrating an example process performed, for example, by a UE, in accordance with the present disclosure.

FIG. 13 is a diagram illustrating an example process performed, for example, by a UE, in accordance with the present disclosure.

FIG. 14 is a diagram illustrating an example process performed, for example, by a UE, in accordance with the present disclosure.

FIG. 15 is a diagram of an example apparatus for wireless communication, in accordance with the present disclosure.

FIG. 16 is a diagram of an example apparatus for wireless communication, in accordance with the present disclosure.

### DETAILED DESCRIPTION

In a scenario, a user equipment (UE) may receive a first physical downlink control channel (PDCCH) order downlink control information (DCI) that schedules a first physical random access channel (PRACH) message, but the first PRACH message may fail to be transmitted or received. A second PDCCH order DCI may schedule a second PRACH message. However, it is not clear if the second PRACH message is for an initial transmission of a new PRACH message or for a retransmission of the failed first PRACH message. This is an issue because the UE may need to increase the transmit power for retransmissions to better ensure its success. According to various aspects described herein, a UE may transmit a PRACH message with a transmit power that is based on whether the PRACH message is an initial transmission or a retransmission. As a result, power and signaling resources our conserved.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

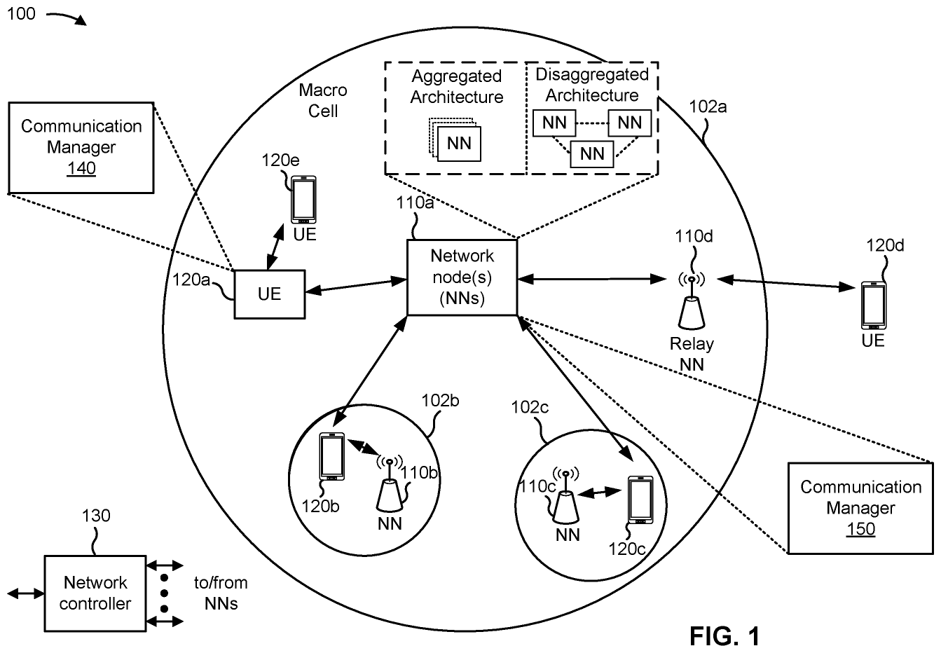

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an ENB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage arcas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (cMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FRI, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a UE 120) may include a communication manager 140. As described in more detail elsewhere herein, the communication manager 140 may receive a PDCCH order DCI that is for transmission of a PRACH message to a candidate cell. The communication manager 140 may transmit the PRACH message with a transmit power that is based at least in part on whether the PDCCH order DCI applies to an initial transmission or a retransmission.

In some aspects, the communication manager 140 may transmit a random access channel (RACH) message to a candidate cell based at least in part on receiving a PDCCH order DCI from a serving cell. The communication manager 140 may select a beam to receive a random access response (RAR). The communication manager 140 may receive the RAR using the beam.

In some aspects, the communication manager 140 may trigger a first RACH procedure for layer 1 or layer 2 triggered mobility (LTM). The communication manager 140 may trigger a second RACH procedure. The communication manager 140 may transmit a PRACH message for the first RACH procedure or the second RACH procedure based at least in part on a prioritization rule or condition.

In some aspects, the communication manager 140 may receive a component carrier (CC) configuration for one or more CC lists that each include at least one multiple transmit receive point (mTRP) CC and at least one single TRP (sTRP) CC. The communication manager 140 may receive a transmission configuration indicator (TCI) state configuration for a CC in a CC list of the one or more CC lists. The communication manager 140 may apply the TCI state configuration to all CCs in the CC list. Additionally, or alternatively, the communication manager 140 may perform one or more other operations described herein.

In some aspects, a network entity (e.g., a network node 110) may include a communication manager 150. The communication manager 150 may transmit a CC configuration for one or more CC lists that each include at least one mTRP CC and at least one sTRP CC. The communication manager 150 may transmit a TCI state configuration for a CC in a CC list of the one or more CC lists. Additionally, or alternatively, the communication manager 150 may perform one or more other operations described herein.

As indicated above, FIG. 1 is provided as an example. Other examples may differ from what is described with regard to FIG. 1.

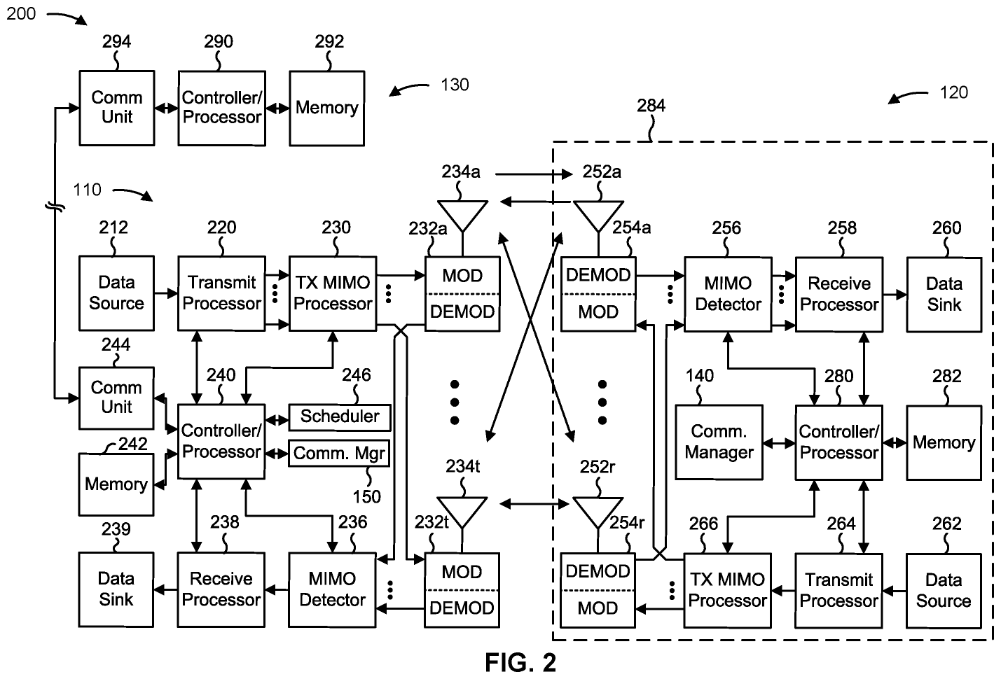

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

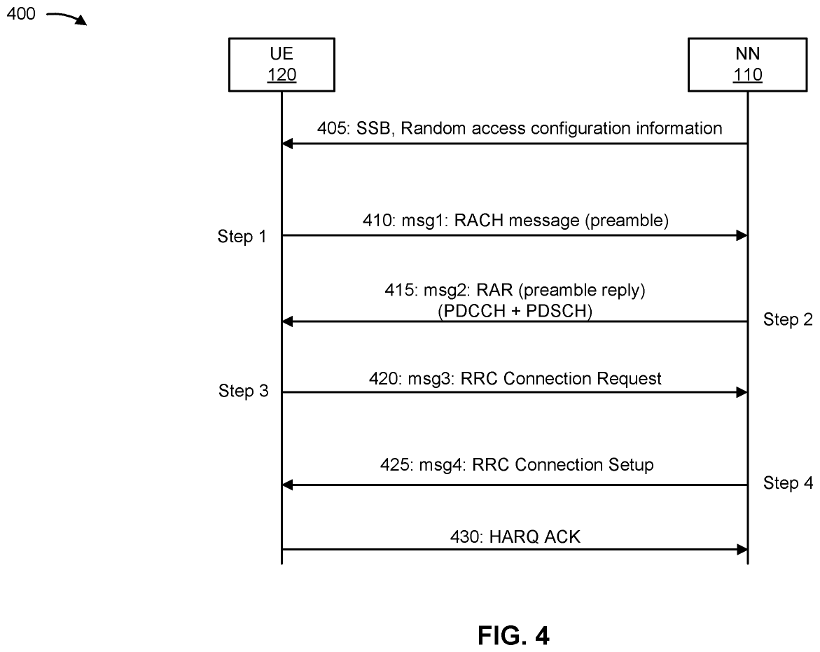

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-16).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-16).

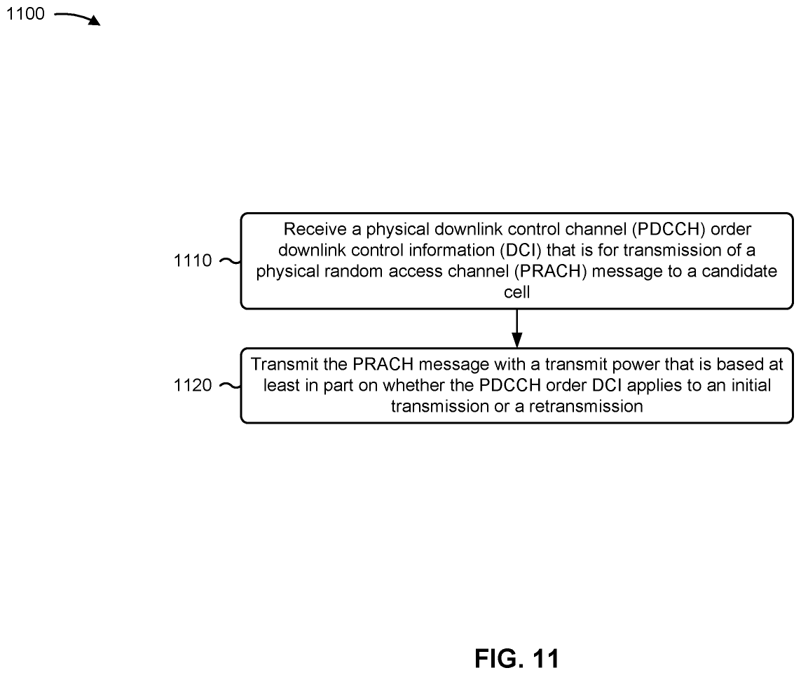

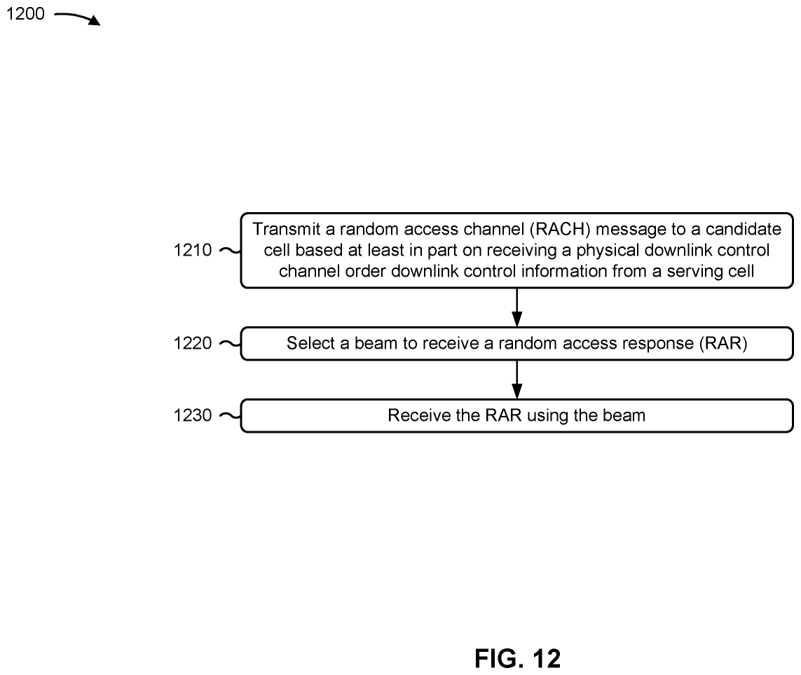

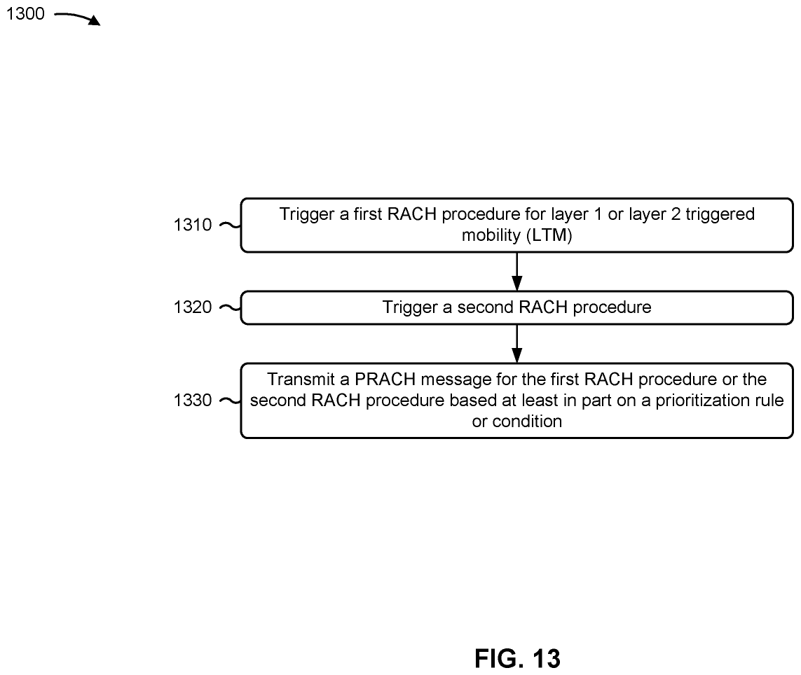

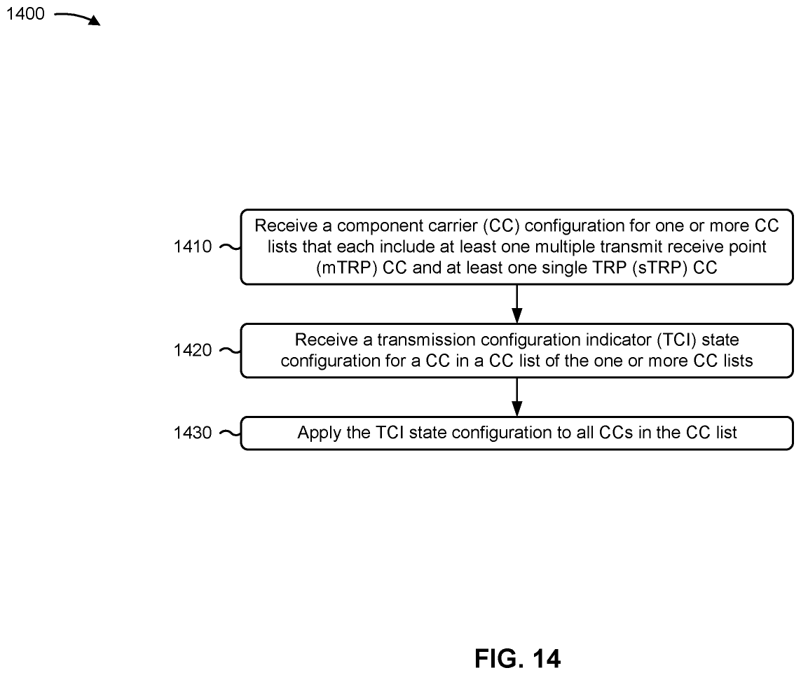

A controller/processor of a network entity (e.g., controller/processor 240 of the network node 110), the controller/processor 280 of the UE 120, and/or any other component(s) of FIG. 2 may perform one or more techniques associated with selecting a transmit power or beam for RACH procedure messages, as described in more detail elsewhere herein. For example, the controller/processor 240 of the network node 110, the controller/processor 280 of the UE 120, and/or any other component(s) of FIG. 2 may perform or direct operations of, for example, process 1100 of FIG. 11, process 1200 of FIG. 12, process 1300 of FIG. 13, process 1400 of FIG. 14, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, process 1200 of FIG. 12, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, a UE (e.g., a UE 120) includes means for receiving a PDCCH order DCI that is for transmission of a PRACH message to a candidate cell; and/or means for transmitting the PRACH message with a transmit power that is based at least in part on whether the PDCCH order DCI applies to an initial transmission or a retransmission. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for transmitting a RACH message to a candidate cell based at least in part on receiving a PDCCH order DCI from a serving cell; means for selecting a beam to receive an RAR; and/or means for receiving the RAR using the beam.

In some aspects, the UE includes means for triggering a first RACH procedure for LTM; means for triggering a second RACH procedure; and/or means for transmitting a PRACH message for the first RACH procedure or the second RACH procedure based at least in part on a prioritization rule or condition.

In some aspects, the UE includes means for receiving a CC configuration for one or more CC lists that each include at least one mTRP CC and at least one sTRP CC; means for receiving a TCI state configuration for a CC in a CC list of the one or more CC lists; and/or means for applying the TCI state configuration to all CCs in the CC list.

In some aspects, a network entity (e.g., network node 110) includes means for transmitting a CC configuration for one or more CC lists that each include at least one mTRP CC and at least one sTRP CC; and/or means for transmitting a TCI state configuration for a CC in a CC list of the one or more CC lists. The means for the network entity to perform operations described herein may include, for example, one or more of communication manager 150, antenna 234, modem 232, MIMO detector 236, receive processor 238, transmit processor 220, TX MIMO processor 230, controller/processor 240, or memory 242.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

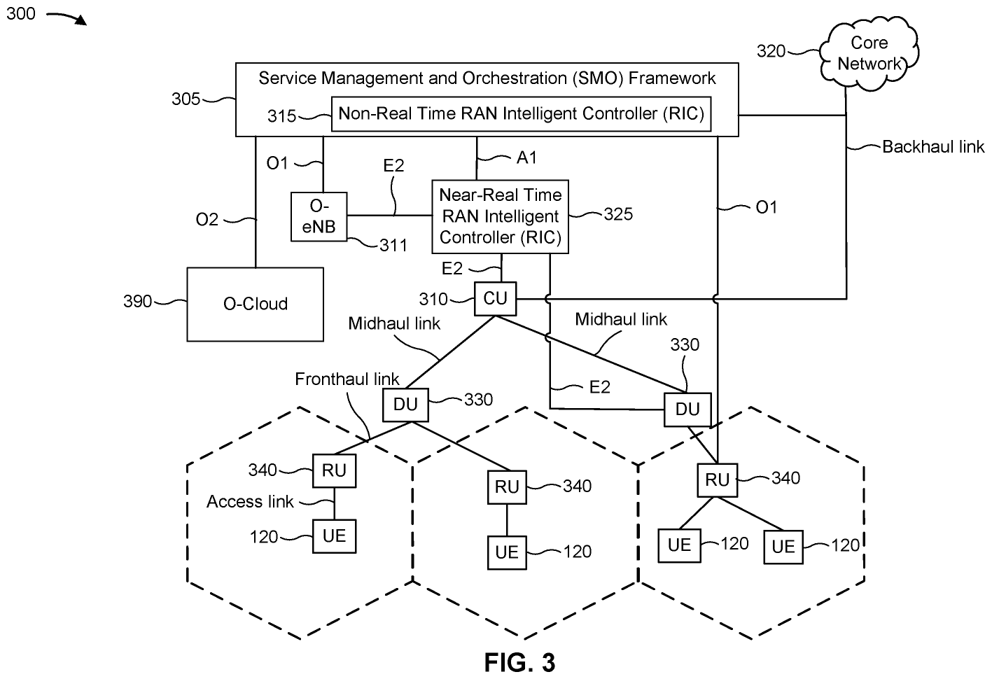

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or PRACH extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-CNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of a four-step random access procedure, in accordance with the present disclosure. As shown in FIG. 4, a network entity (e.g., network node 110) and a UE (e.g., UE 120) may communicate with one another to perform the four-step random access procedure.

As shown by reference number 405, the network node 110 may transmit, and the UE 120 may receive, one or more synchronization signal blocks (SSBs) and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in an RRC message and/or a physical PDCCH order message that triggers a RACH procedure, such as for contention-free random access. The random access configuration information may include one or more parameters to be used in the random access procedure, such as one or more parameters for transmitting a RACH message and/or one or more parameters for receiving an RAR.

As shown by reference number 410, the UE 120 may transmit a RACH message, which may include a preamble (sometimes referred to as a random access preamble, a PRACH preamble, or a RACH message preamble). The message that includes the preamble may be referred to as a message 1, msg1, MSG1, a first message, or an initial message in a four-step random access procedure. The random access message may include a random access preamble identifier.

As shown by reference number 415, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a physical downlink shared channel (PDSCH) communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a medium access control (MAC) protocol data unit (PDU) of the PDSCH communication.

As shown by reference number 420, the UE 120 may transmit an RRC connection request message. The RRC connection request message may be referred to as message 3, msg3, MSG3, or a third message of a four-step random access procedure. In some aspects, the RRC connection request may include a UE identifier, uplink control information (UCI), and/or a physical uplink shared channel (PUSCH) communication (e.g., an RRC connection request).

As shown by reference number 425, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. As shown by reference number 430, if the UE 120 successfully receives the RRC connection setup message, the UE 120 may transmit a hybrid automatic repeat request (HARQ) acknowledgement (ACK).

For PDCCH ordered-RACH for candidate cell(s), RAR reception can be configured/indicated. If reception of an RAR is not configured/indicated (without RAR), the timing advance (TA) value of a candidate cell may be indicated in a cell switch command. However, the transmit power for subsequent messages has not been specified if an RAR is not configured/indicated. Also, if an RAR is not configured/indicated, the UE may or may not be allowed to autonomously retransmit a PRACH.

As indicated above, FIG. 4 is provided as an example. Other examples may differ from what is described with regard to FIG. 4.

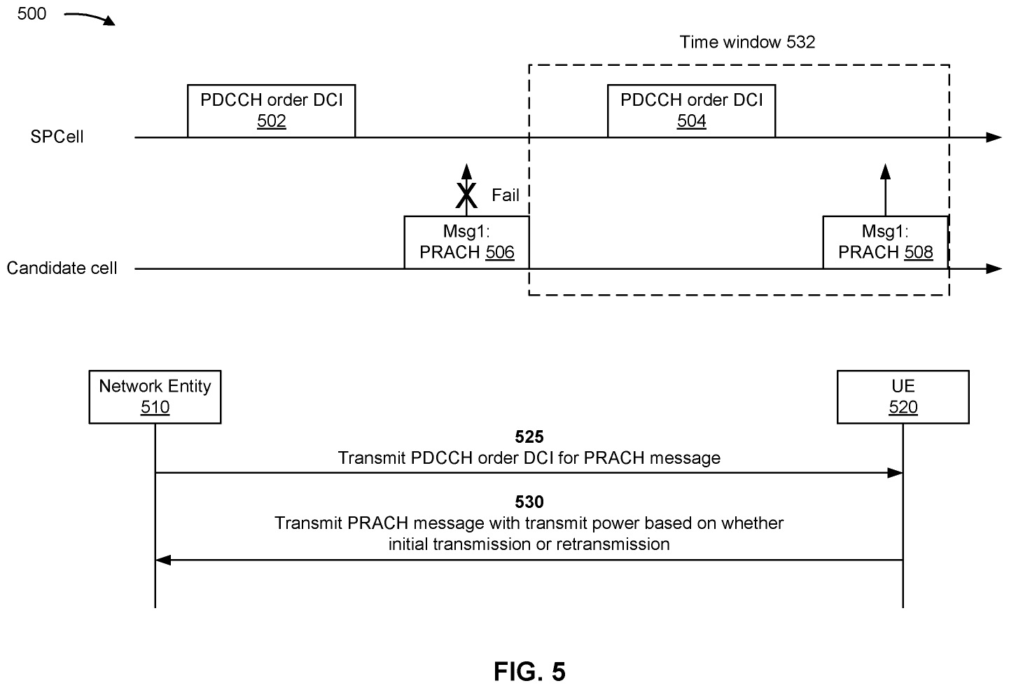

FIG. 5 is a diagram illustrating an example 500 of PDCCH order DCIs, in accordance with the present disclosure.

In a scenario, a first PDCCH order DCI may schedule a first PRACH message (Msg1) but the first PRACH message may fail to be transmitted or received. A second PDCCH order DCI may schedule a second PRACH message. However, it is not clear if the second PRACH message as for an initial transmission of a new PRACH message or for a retransmission of the failed first PRACH message. This is an issue because the UE may need to increase the transmit power for retransmissions to better ensure its success. If the transmit power is not high enough for a retransmission, the retransmission may fail, which wastes power and signaling resources. If the transmit power does not need to be increased (for an initial transmission rather than a retransmission), a higher transmit power would be a waste of power.

According to various aspects described herein, a UE may transmit a PRACH message with a transmit power that is based on whether the PRACH message is an initial transmission or a retransmission. Example 500 shows reception of a first PDCCH order DCI 502 and a second PDCCH order DCI 504. Example 500 also shows a failed transmission of a first PRACH message (Msg 1) 506 and a transmission of a second PRACH message 508.

Example 500 also shows a network entity 510 (e.g., network node 110) and a UE 520 (e.g., a UE 120) that may communicate with one another over wireless network (e.g., wireless network 100). As shown by reference number 525, the network entity 510 may transmit the second PDCCH order DCI 504 for the second PRACH message 508. The UE 520 may receive the second PDCCH order DCI 504.

As shown by reference number 530, the UE 520 may transmit the second PRACH message 508 with a transmit power that is based at least in part on whether the second PRACH message 508 is an initial transmission or a retransmission of the first PRACH message 506. The UE 520 may increase the transmit power for a retransmission as compared to an initial transmission. In some aspects, the second PDCCH order DCI 504 may include an explicit indicator, such as a bit (e.g., flag) or value in a field or counter, that indicates whether the second PDCCH order DCI 504 is for an initial transmission or a retransmission. The bit or value may apply only to the PRACH message triggered for the same candidate cell and/or the same SSB.

In some aspects, the UE 520 may set the transmit power for a retransmission if the second PDCCH order DCI 504 is received within a time window 532 associated with a previous PDCCH order DCI (the first PDCCH order DCI 502) or set the transmit power for an initial transmission if the second PDCCH order DCI 504 is received outside the time window 532. The network entity 510 may configured a start time and length for the time window 532 via RRC signaling. In some aspects, the start of the time window 532 may be based at least in part on a transmission time of the first PRACH message 506 scheduled by the first PDCCH order DCI 502. The start of the time window 532 may be at the start of transmission of the first PRACH message 506 or at the end of the transmission of the first PRACH message 506. Alternatively, in some aspects, the start of the time window 532 may be based at least in part on a reception time of the first PDCCH order DCI 502, such as the start or at the end of the reception of the first PDCCH order DCI 502.

By using an explicit indicator or the time window 532 to determine whether a PRACH message is an initial transmission or a retransmission, the UE 520 may set a transmit power that is appropriate for the PRACH message. As a result, power and signaling resources are conserved.

As indicated above, FIG. 5 is provided as an example. Other examples may differ from what is described with regard to FIG. 5.

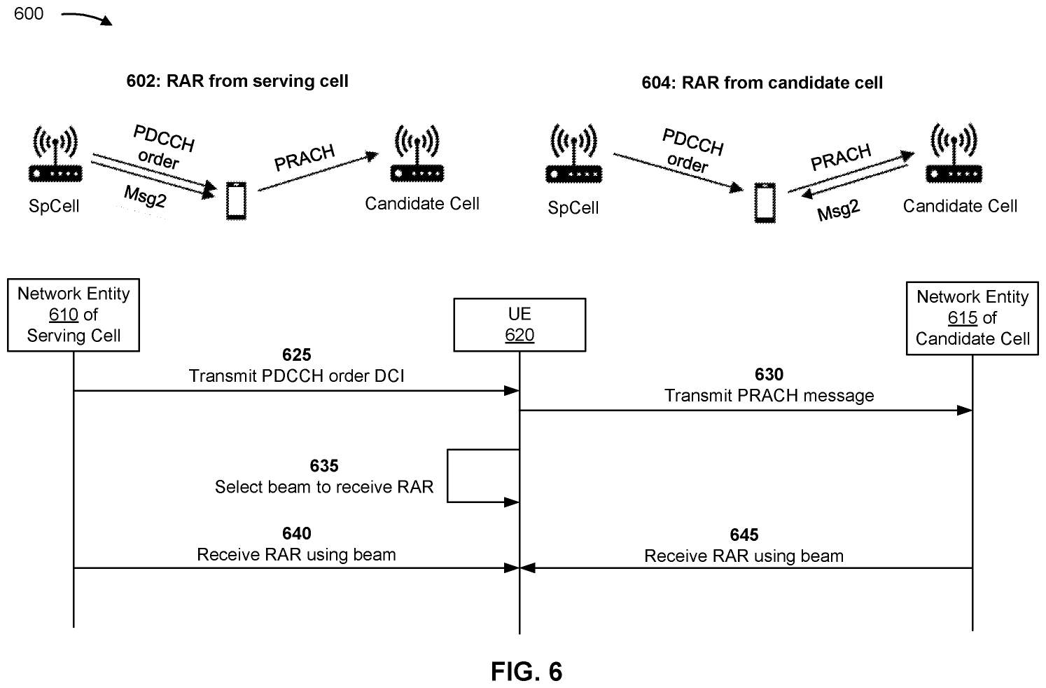

FIG. 6 is a diagram illustrating an example 600 of RARs, in accordance with the present disclosure. Example 600 shows a network entity 610 (e.g., network node 110) for a serving cell (e.g., secondary primary cell (SpCell)) and a network entity 615 (e.g., network node 110) for a candidate cell that may communicate with a UE 620 (e.g., a UE 120) over a wireless network (e.g., wireless network 100).

UE mobility may be handled using Layer (L1) or Layer (L2) signaling. Such mobility may be referred to as LTM. LTM may contrast with 3GPP standard releases that are earlier than Release 18 and that do not specify the triggering of mobility procedures using L1/L2 signaling. The UE 620 may support a baseline approach for LTM, where the UE 620 supports using a specific configuration (e.g., for a TA) by receiving an RAR or supports using a specific configuration without receiving an RAR.

As shown by reference number 625, the network entity 610 of the serving cell may transmit a PDCCH order DCI to schedule a PRACH message. As shown by reference number 630, the UE 620 may transmit a PRACH message (Msg 1) to a network entity 615 of the candidate cell. The UE 620 may expect to receive an RAR (Msg 2). However, the configuration used by the UE 620 may depend on whether the RAR is received from the serving cell (shown by scenario 602) or received from the candidate cell (shown by scenario 604), which may be a target cell.

The configuration may include selection of a beam to receive the RAR. The UE 620 may select a beam to receive an RAR based at least in part on whether the RAR is received from the serving cell or a candidate cell. In some aspects, if the RAR is received from the serving cell, the UE 620 may select a beam that corresponds to a transmit beam used for a Type 1 common search space (CSS) control resource set (CORESET), which may or may not be the indicated TCI state. The UE 620 may select a beam that corresponds to the transmit beam used for the PDCCH order DCI.

Selecting a beam that corresponds to a transmit beam from a cell may include selecting a receive beam with a spatial relation or TCI state that matches or is paired with the transmit beam. This may involve a joint TCI state, a unified TCI state, or a quasi-co-located beam.

In some aspects, if the RAR is received from the candidate cell, the UE 620 may select a beam that corresponds to a transmit beam used for a Type 1 CSS CORESET, which may or may not be the indicated TCI state. However, if the candidate cell is not configured with a Type 1 CSS, the UE 620 may use a default beam. The UE 620 may select a beam that corresponds to a transmit beam used for a downlink reference signal associated with a PRACH message.

As shown by reference number 635, the UE 620 may select the beam to receive the RAR. The UE 620 may select the beam based at least in part on whether the RAR is from the serving cell or the candidate cell, as described above. As shown by reference number 640, the UE 620 may receive the RAR from the serving cell using a selected beam. As shown by reference number 645, the UE 620 may alternatively receive the RAR from the candidate cell using the selected beam. By using a rule to select a beam for receiving the RAR, the UE 620 may improve the likelihood of successfully receiving and decoding an RAR. As a result, signaling resource are conserved and not wasted.

As indicated above, FIG. 6 is provided as an example. Other examples may differ from what is described with regard to FIG. 6.

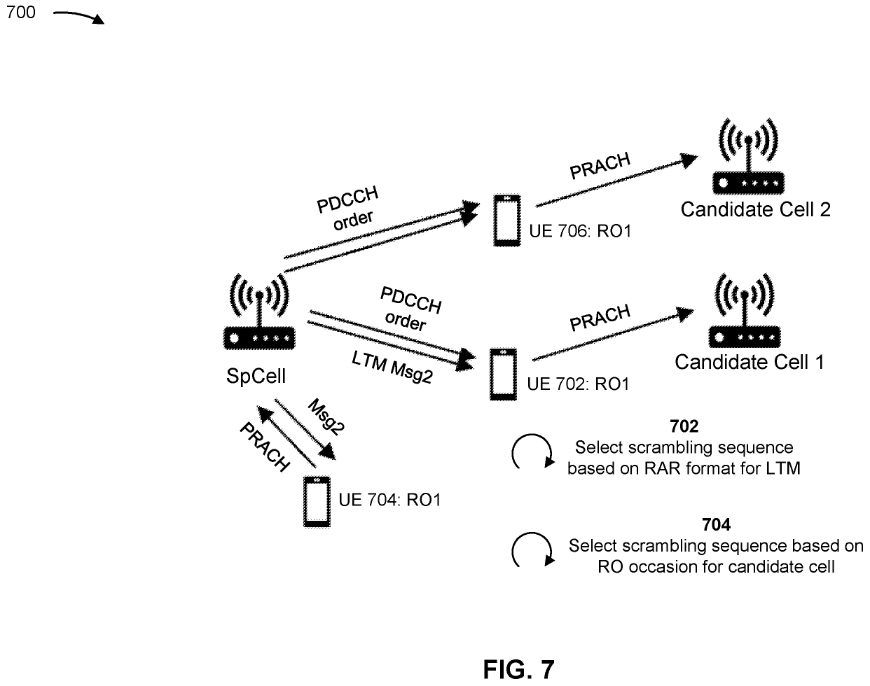

FIG. 7 is a diagram illustrating an example 700 of RARs, in accordance with the present disclosure.

In some scenarios, a UE may transmit a PRACH message and then receive more than one RAR in a RACH occasion (RO), due to multiple UEs having the same configuration. Example 700 shows that the UE may receive multiple RARs from the SpCell, candidate cell 1, or candidate cell 2 in the same RO 1. The UE may not be able to determine if the RAR is addressed to the UE.

In some aspects, the UE may determine a scrambling sequence (e.g., radio network temporary identifier (RNTI)) used to decode an RAR based at least in part on whether the RAR is from a serving cell or a candidate cell. For example, if the RAR is from the serving cell, the UE may calculate a random access (RA) RNTI (RA-RNTI) based at least in part on the RO on the candidate cell. As the RAR may collide with RARs from other UEs that use the RO (e.g., for initial access), the UE may, in some aspects, determine the scrambling sequence used to decode the RAR based at least in part on a format of the RAR that is specific to LTM (different than a legacy RAR format), as shown by reference number 702. In some aspects, the network entity may allocate two UEs for LTM PRACH with non-conflicted ROs in the same serving cell. In some aspects, the UE may use the cell-specific RNTI (C-RNTI) of the serving cell to decode the RAR. In some aspects, the UE may reserve a RO that can cause a collision in the serving cell.

The RAR may be from a candidate cell. In some aspects, the UE may compute the RA-RNTI based at least in part on the RO for the candidate cell, as shown by reference number 704. The UE may use the RA-RNTI to decode the RAR from the candidate cell. In some aspects, the UE may use the C-RNTI, but the candidate cell C-RNTI may not be configured at the UE.

In some aspects, the UE may determine whether to provide feedback (e.g., ACK) for the RAR. If the RAR is from a serving cell, the UE may provide no ACK to the serving cell for the RAR, provide a PUSCH communication scheduled by the RAR (if he RAR format includes an UL grant), or provide an ACK for a PDSCH communication that includes an RAR MAC CE.

In some aspects, if the RAR is from a candidate cell, the UE may provide no ACK to the candidate cell for the RAR or provide a PUSCH communication scheduled by the RAR. The UE may transmit the PUSCH communication to the serving cell or the candidate cell.

There may be a gap time between an PRACH message and an RAR window. In some aspects, the gap time may be based at least in part on whether the PRACH message is for LTM. For example, the UE may expect to use a longer gap time for LTM PRACH messages than for legacy PRACH messages. In some aspects, the UE may expect to use a longer gap time for LTM PRACH messages between the RAR window and the next PRACH message, if no RAR is received.

In some aspects, the longer gap time may be expected for only a subset of LTM use cases, such as when the RAR is received from the serving and the PRACH message is on the candidate cell. The candidate cell may be an inter-frequency cell. The candidate cell may not be an UL serving cell, where a physical uplink control channel (PUCCH) or a PUSCH is not configured.

As indicated above, FIG. 7 is provided as an example. Other examples may differ from what is described with regard to FIG. 7.

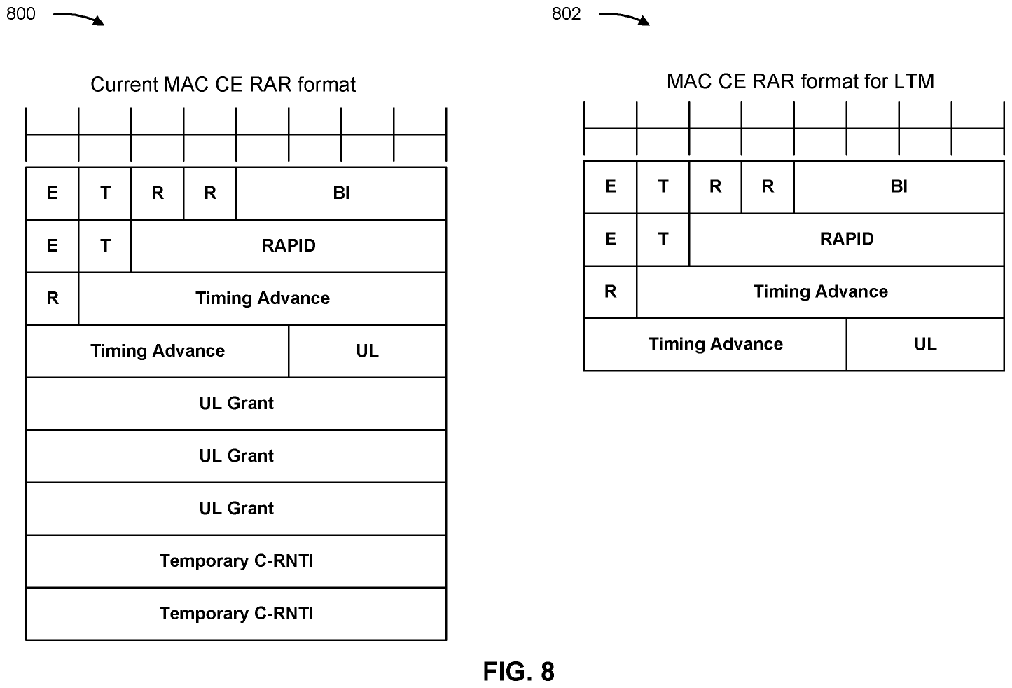

FIG. 8 is a diagram illustrating examples 800 and 802 of MAC CE formats for RAR, in accordance with the present disclosure.

An RAR may be included in a MAC CE with a format that is used to select a TA value. The RAR may indicate at least a TA of a candidate cell. A UE may support a maximum quantity of TA values. The RAR may include other values. Example 802 shows a current or legacy RAR sub-header format in a MAC CE.

In some aspects, if the RAR is from a serving cell, the UE may use an RAR format that is different than that the legacy RAR sub-header format. The RAR sub-header format may be specific to LTM. For example, as shown by example 802, the RAR sub-header format may not contain an uplink (UL) grant or temporary C-RNTI information. In some aspects, for an RAR from a serving cell, the legacy RAR sub-header format may be used but with values (e.g., a sequence in reserved bits) that distinguish the RAR for LTM from the legacy RAR. For example, the UE may determine a TA value based at least in part on the RAR being included in a MAC CE with a bit or value that is specific to LTM.

In some aspects, the RAR is from a candidate cell. The RAR sub-header format or values may be different for LTM.

In some aspects, for UE-based TA measurement, the network entity may indicate which two cells to measure the downlink receive timing difference. The network entity may indicate which downlink (DL) reference signal (RS) and/or bandwidth part (BWP) of which cell. In some aspects, for a sounding reference signal (SRS) triggered by an LTM cell switch command, the network entity may indicate a detailed SRS resource configuration for a candidate cell. The configuration may be for periodic, semi-persistent, or aperiodic SRS. The UE may determine the configuration by an implicit rule. For example, the UE may use an SRS configuration of an SRS that has a TCI state with a root quasi-co-location (QCL) source as an SSB in the indicated TCI state in the LTM cell switch command.

As indicated above, FIG. 8 is provided as an example. Other examples may differ from what is described with regard to FIG. 8.

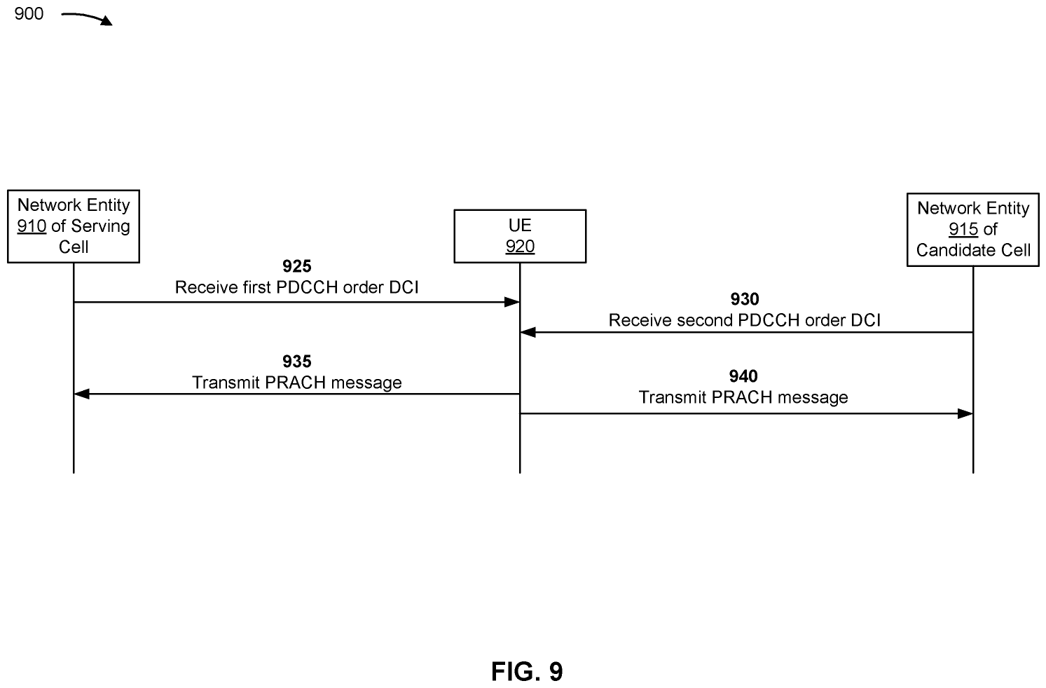

FIG. 9 is a diagram illustrating an example 900 of RACH prioritization, in accordance with the present disclosure. Example 900 shows a network entity 910 (e.g., network node 110) for a serving cell and a network entity 915 (e.g., network node 110) for a candidate cell that may communicate with a UE 920 (e.g., a UE 120) over a wireless network (e.g., wireless network 100).

In some scenarios, the UE 920 may receive a first PDCCH order DCI to trigger a first RACH procedure. As shown by reference number 925, the first PDCCH order DCI is from the serving cell. A first RACH procedure is triggered. The RACH procedure may be for LTM and may use a TA for LTM. However, the UE 920 may be triggered for another RACH procedure before the current RACH procedure is completed. For example, the UE 920 may receive a second PDCCH order DCI to trigger a second RACH procedure. As shown by reference number 930, the second PDCCH order DCI is from the candidate cell. The UE 920 does not have information as to which RACH procedure to prioritize.

In some aspects, the UE 920 may prioritize one of the RACH procedures based at least in part on a prioritization rule or condition. The prioritization rule or condition may specify that RACH procedures are to be prioritized based at least in part on a RACH procedure type. There may be a priority order for RACH procedure types. For example, a beam failure recovery (BFR) PRACH message may have a higher priority than an LTM TA PRACH message and thus the BFR PRACH message is transmitted first. The LTM TA PRACH message may be transmitted later or dropped.

In some aspects, the prioritization rule or condition may specify that RACH procedures are to be prioritized based at least in part on whether a RACH procedure is for a serving cell or a candidate cell. For example, the UE 920 may transmit a PRACH message to the serving cell, as shown by reference number 935, before transmitting a PRACH message to the candidate cell, as shown by reference number 940.

In some aspects, the prioritization rule or condition may specify that RACH procedures are to be prioritized based at least in part on a RACH procedure triggering time. For example, whichever RACH message was triggered first has priority. In some aspects, the prioritization rule or condition may specify that RACH procedures are to be prioritized based at least in part on a candidate cell identifier (ID). For example, one candidate cell may have priority over another candidate cell or over a serving cell. The UE 920 may identify a candidate cell based on the candidate cell ID.

As indicated above, FIG. 9 is provided as an example. Other examples may differ from what is described with regard to FIG. 9.

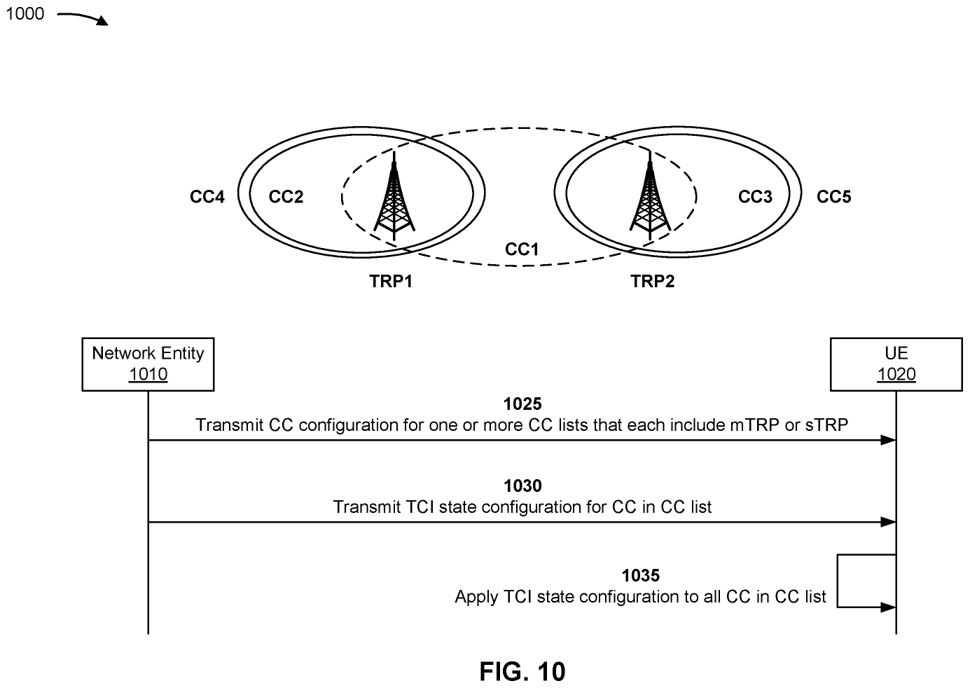

FIG. 10 is a diagram illustrating an example 1000 of CC lists, in accordance with the present disclosure.

A UE may communicate with a single TRP in a sTRP operating mode or communicate with multiple TRPs in a multi-TRP (mTRP) operating mode. The UE may communicate using CCs that are configured for use with an sTRP mode or an mTRP mode. A UE may use one configuration for an sTRP CC and a different configuration for an mTRP CC. A network entity may have to signal a TCI state configuration, a TCI state activation, or provide a TCI state indication for each sTRP CC or mTRP CC. Example 1000 shows a TRP1 and TRP2, where TRP1 may be associated with an sTRP CC configuration, TRP2 may be associated with an sTRP CC configuration, and TRP1 and TRP2 may be jointly associated with an mTRP CC configuration.

A UE may use a group of CCs, but this will increase the signaling overhead as a mixed group of sTRP CCs and mTRP CCs is not supported. One group or list of CCs is to be configured for each category. Example 100 shows that there are to be three CC lists: {CC1}, {CC2, CC4}, and {CC3, CC5} as {CC2, CC4} and {CC3, CC5}, which are associated with two different TRPs (TRP1 and TRP 2). A network entity is to configure/activate/indicate TCI states in three reference CCs, and the UE is to maintain TCI states for the three CC lists. In practice, when the quantity of serving TRPs is larger, the quantity of CC categories can quickly increase. This results in a large complexity due to the maintenance of a large quantity of CC lists and a large overhead for TCI state configuration/activation/indication signaling.

In some aspects, such issues may be mitigated or avoided if sTRP cells and mTRP cells can be configured in a CC list, where two CC lists is enough (i.e., {CC1, CC2, CC4} and {CC1, CC3, CC5}) as the mTRP cell CC1 is configured in both CC lists. The network entity may have the freedom to select any of the CCs in the CC list as the reference CC to that list.

Example 1000 shows use of mixed CC lists. As shown by reference number 1025, the network entity 1010 may transmit a CC configuration for one or more CC lists that each include an mTRP CC and an sTRP CC. As shown by reference number 1030, the network entity 1010 may transmit a TCI state configuration for a CC in a CC list. As shown by reference number 1035, the UE 1020 may apply the TCI state configuration to all CCs in the CC list. This means that the same TCI state configuration will be applied to both an sTRP and an mTRP. In some aspects, the UE 1020 may apply the TCI state configuration to CCs in another list.

In some aspects, the TCI state configuration configures an mTRP CC as a reference CC, and the UE 1020 may apply the TCI state configuration to sTRP CCs in the CC list. If an mTRP CC (CC1 in example 1000) is configured as the reference CC for both lists, the two joint TCI states or two pair of (DL,UL) TCI states that are indicated in CC1, may be applied to the two CC lists respectively. For example, the first joint TCI state or the first pair of (DL, UL) TCI states may also be applied to the other CCs in the first CC list (i.e., CC2 and CC4). The second joint TCI state or the second pair of UL/DL TCI states may also be applied to the other CCs in the second CC list (i.e., CC3 and CC5). Therefore, the quantity of CC lists is reduced from 3 to 2, and the number of TCI configuration/activation/indication signaling is reduced from 3x to 1x, where x is the quantity of RRC/MAC CE/DCI signaling messages for TCI state configuration/activation/indication.

In some aspects, the TCI state configuration configures an sTRP CC as a reference CC, and the UE 1020 may apply the TCI state configuration to mTRP CCs in the CC list. If an sTRP CC (e.g., CC2 in {CC1, CC2, CC4} and CC3 in {CC1, CC3, CC5}) is the reference CC for its corresponding CC list, the joint/(DL, UL) TCI state of the first CC group {CC1, CC2, CC4} may also be applied to the first TCI state of the mTRP CC in that group (CC1). The joint/(DL, UL) TCI state of the second CC group {CC1, CC3, CC5} may also be applied to the second TCI state of the mTRP CC in that group (CC1). In such a case, the quantity of CC lists is again reduced from 3 to 2, and the quantity of TCI configuration/activation/indication signaling messages is reduced from 3x to 2x.

In some aspects, the UE 1020 may determine which TRP mode a CC is set for, whether for sTRP, multiple DCI (mDCI) mTRP, or single DCI (sDCI) mTRP. In some aspects, there may be an RRC flag per CC. The RRC flag may be a part of a CC configuration. The RRC flag may be part of a CC list configuration (e.g., a bitmap flags for CCs in a list). In some aspects, the UE 1020 may determine the TRP modes for CCs based at least in part on a MAC CE or DCI. For example, a TCI state activation MAC CE for a CC of the CC list may include a bitmap to indicate TRP modes of all CCs in the CC list. In some aspects, the UE 1020 may determine the TRP modes for CCs based at least in part on another configuration, such as a CORESET pool ID that is configured to determine whether a CC is mDCI mTRP.

As indicated above, FIG. 10 is provided as an example. Other examples may differ from what is described with regard to FIG. 10.

FIG. 11 is a diagram illustrating an example process 1100 performed, for example, by a UE, in accordance with the present disclosure. Example process 1100 is an example where the UE (e.g., UE 120, UE 520) performs operations associated with setting a transmit power for PRACH messages.

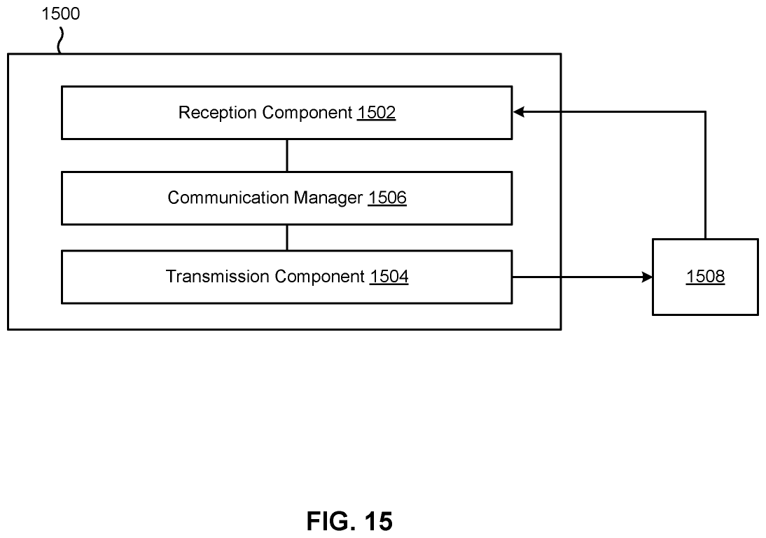

As shown in FIG. 11, in some aspects, process 1100 may include receiving a PDCCH order DCI that is for transmission of a PRACH message to a candidate cell (block 1110). For example, the UE (e.g., using reception component 1502 and/or communication manager 1506, depicted in FIG. 15) may receive a PDCCH order DCI that is for transmission of a PRACH message to a candidate cell, as described above in connection with FIG. 4 and FIG. 5.

As further shown in FIG. 11, in some aspects, process 1100 may include transmitting the PRACH message with a transmit power that is based at least in part on whether the PDCCH order DCI applies to an initial transmission or a retransmission (block 1120). For example, the UE (e.g., using transmission component 1504 and/or communication manager 1506, depicted in FIG. 15) may transmit the PRACH message with a transmit power that is based at least in part on whether the PDCCH order DCI applies to an initial transmission or a retransmission, as described above in connection with FIG. 4 and FIG. 5.

Process 1100 may include additional aspects, such as any single aspect or any combination of aspects described below and/or in connection with one or more other processes described elsewhere herein.

In a first aspect, the PDCCH order DCI includes a bit or value that indicates whether the PDCCH order DCI applies to an initial transmission or a retransmission.

In a second aspect, alone or in combination with the first aspect, the transmit power is set for a retransmission based at least in part on the PDCCH order DCI being received within a time window associated with a previous PDCCH order DCI, or set for an initial transmission based at least in part on the PDCCH order DCI being received outside of the time window.

In a third aspect, alone or in combination with one or more of the first and second aspects, a start of the time window is based at least in part on a previous PRACH message transmission time scheduled by the previous PDCCH order DCI.

In a fourth aspect, alone or in combination with one or more of the first through third aspects, a start of the time window is based at least in part on a reception time of the previous PDCCH order DCI.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a UE, in accordance with the present disclosure. Example process 1200 is an example where the UE (e.g., UE 120, UE 620) performs operations associated with selecting a beam to receive a RACH message (e.g., RAR).

As shown in FIG. 12, in some aspects, process 1200 may include transmitting a RACH message to a candidate cell based at least in part on receiving a PDCCH order DCI from a serving cell (block 1210). For example, the UE (e.g., using transmission component 1504 and/or communication manager 1506, depicted in FIG. 15) may transmit a RACH message to a candidate cell based at least in part on receiving a PDCCH order DCI from a serving cell, as described above in connection with FIGS. 4-8.

As further shown in FIG. 12, in some aspects, process 1200 may include selecting a beam to receive an RAR (block 1220). For example, the UE (e.g., using communication manager 1506, depicted in FIG. 15) may select a beam to receive an RAR, as described above.

As further shown in FIG. 12, in some aspects, process 1200 may include receiving the RAR using the beam (block 1230). For example, the UE (e.g., using reception component 1502 and/or communication manager 1506, depicted in FIG. 15) may receive the RAR using the beam, as described above in connection with FIGS. 4-8.

Process 1200 may include additional aspects, such as any single aspect or any combination of aspects described below and/or in connection with one or more other processes described elsewhere herein.

In a first aspect, selecting the beam includes selecting a beam that corresponds to a transmit beam used for a Type 1 CSS CORESET.

In a second aspect, alone or in combination with the first aspect, selecting the beam includes selecting a beam that corresponds to a transmit beam used for a PDCCH order DCI.

In a third aspect, alone or in combination with one or more of the first and second aspects, selecting the beam includes selecting a default beam.

In a fourth aspect, alone or in combination with one or more of the first through third aspects, selecting the beam includes selecting a beam that corresponds to a beam used for a downlink reference signal associated with a PRACH message.

In a fifth aspect, alone or in combination with one or more of the first through fourth aspects, process 1200 includes determining a scrambling sequence used to decode the RAR based at least in part on whether the RAR is from a serving cell or a candidate cell.

In a sixth aspect, alone or in combination with one or more of the first through fifth aspects, determining the scrambling sequence includes determining the scrambling sequence based at least in part on a format of the RAR that is specific to LTM.

In a seventh aspect, alone or in combination with one or more of the first through sixth aspects, process 1200 includes reserving a RACH occasion.

In an eighth aspect, alone or in combination with one or more of the first through seventh aspects, determining the scrambling sequence includes determining the scrambling sequence based at least in part on a RACH occasion for a candidate cell.

In a ninth aspect, alone or in combination with one or more of the first through eighth aspects, process 1200 includes determining a timing advance value based at least in part on the RAR being included in a MAC CE with an RAR sub-header format that is specific to LTM.

In a tenth aspect, alone or in combination with one or more of the first through ninth aspects, process 1200 includes determining a TA value based at least in part on the RAR being included in a MAC CE with a bit or value that is specific to LTM.

In an eleventh aspect, alone or in combination with one or more of the first through tenth aspects, process 1200 includes determining whether to provide feedback for the RAR.

In a twelfth aspect, alone or in combination with one or more of the first through eleventh aspects, a gap time between a PRACH message and the RAR is based at least in part on whether the PRACH message is for LTM.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a UE, in accordance with the present disclosure. Example process 1300 is an example where the UE (e.g., UE 120, UE 920) performs operations associated with prioritizing RACH procedures.

As shown in FIG. 13, in some aspects, process 1300 may include triggering a first RACH procedure for LTM (block 1310). For example, the UE (e.g., using communication manager 1506, depicted in FIG. 15) may trigger a first RACH procedure for LTM, as described above.

As further shown in FIG. 13, in some aspects, process 1300 may include triggering a second RACH procedure (block 1320). For example, the UE (e.g., using communication manager 1506, depicted in FIG. 15) may trigger a second RACH procedure, as described above in connection with FIGS. 4-9.

As further shown in FIG. 13, in some aspects, process 1300 may include transmitting a PRACH message for the first RACH procedure or the second RACH procedure based at least in part on a prioritization rule or condition (block 1330). For example, the UE (e.g., using transmission component 1504 and/or communication manager 1506, depicted in FIG. 15) may transmit a PRACH message for the first RACH procedure or the second RACH procedure based at least in part on a prioritization rule or condition, as described above in connection with FIGS. 4-9.

Process 1300 may include additional aspects, such as any single aspect or any combination of aspects described below and/or in connection with one or more other processes described elsewhere herein.

In a first aspect, the prioritization rule or condition specifies that RACH procedures are to be prioritized based at least in part on a RACH procedure type.

In a second aspect, alone or in combination with the first aspect, the prioritization rule or condition specifies that RACH procedures are to be prioritized based at least in part on whether a RACH procedure is for a serving cell or a candidate cell.

In a third aspect, alone or in combination with one or more of the first and second aspects, the prioritization rule or condition specifies that RACH procedures are to be prioritized based at least in part on a RACH procedure triggering time.

In a fourth aspect, alone or in combination with one or more of the first through third aspects, the prioritization rule or condition specifies that RACH procedures are to be prioritized based at least in part on a candidate cell ID.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a UE, in accordance with the present disclosure. Example process 1400 is an example where the UE (e.g., UE 120, UE 1020) performs operations associated with configuring CCs.

As shown in FIG. 14, in some aspects, process 1400 may include receiving a CC configuration for one or more CC lists that each include at least one mTRP CC and at least one sTRP CC (block 1410). For example, the UE (e.g., using reception component 1502 and/or communication manager 1506, depicted in FIG. 15) may receive a CC configuration for one or more CC lists that each include at least one mTRP CC and at least one sTRP CC, as described above in connection with FIGS. 4-5 and 10.

As further shown in FIG. 14, in some aspects, process 1400 may include receiving a TCI state configuration for a CC in a CC list of the one or more CC lists (block 1420). For example, the UE (e.g., using reception component 1502 and/or communication manager 1506, depicted in FIG. 15) may receive a TCI state configuration for a CC in a CC list of the one or more CC lists, as described above in connection with FIGS. 4-5 and 10.

As further shown in FIG. 14, in some aspects, process 1400 may include applying the TCI state configuration to all CCs in the CC list (block 1430). For example, the UE (e.g., using communication manager 1506, depicted in FIG. 15) may apply the TCI state configuration to all CCs in the CC list, as described above in connection with FIGS. 4-5 and 10.

Process 1400 may include additional aspects, such as any single aspect or any combination of aspects described below and/or in connection with one or more other processes described elsewhere herein.

In a first aspect, the TCI state configuration configures an mTRP CC as a reference CC, and applying the TCI state configuration includes applying the TCI state configuration to sTRP CCs in the CC list.

In a second aspect, alone or in combination with the first aspect, the TCI state configuration configures an sTRP CC as a reference CC, and applying the TCI state configuration includes applying the TCI state configuration to mTRP CCs in the CC list.

In a third aspect, alone or in combination with one or more of the first and second aspects, process 1400 includes applying the TCI state configuration to CCs in another CC list of the one or more CC lists.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE (e.g., UE 120, UE 520, UE 620, UE 920, UE 1020), or a UE may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 140 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 1-10. Additionally, or alternatively, the apparatus 1500 may be configured to perform one or more processes described herein, such as process 1100 of FIG. 11, process 1200 of FIG. 12, process 1300 of FIG. 12, process 1400 of FIG. 14, or a combination thereof. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

In some aspects, the reception component 1502 may receive a PDCCH order DCI that is for transmission of a PRACH message to a candidate cell. The transmission component 1504 may transmit the PRACH message with a transmit power that is based at least in part on whether the PDCCH order DCI applies to an initial transmission or a retransmission.

In some aspects, the transmission component 1504 may transmit a RACH message to a candidate cell based at least in part on receiving a PDCCH order DCI from a serving cell. The communication manager 1506 may select a beam to receive an RAR. The reception component 1502 may receive the RAR using the beam.

The communication manager 1506 may determine a scrambling sequence used to decode the RAR based at least in part on whether the RAR is from a serving cell or a candidate cell. The communication manager 1506 may reserve a RACH occasion. The communication manager 1506 may determine a TA value based at least in part on the RAR being included in a MAC CE with an RAR sub-header format that is specific to LTM. The communication manager 1506 may determine a TA value based at least in part on the RAR being included in a MAC CE with a bit or value that is specific to LTM. The communication manager 1506 may determine whether to provide feedback for the RAR.

In some aspects, the communication manager 1506 may trigger a first RACH procedure for LTM. The communication manager 1506 may trigger a second RACH procedure. The transmission component 1504 may transmit a PRACH message for the first RACH procedure or the second RACH procedure based at least in part on a prioritization rule or condition.

In some aspects, the reception component 1502 may receive a CC configuration for one or more CC lists that each include at least one TRP CC and at least one sTRP CC. The reception component 1502 may receive a TCI state configuration for a CC in a CC list of the one or more CC lists. The communication manager 1506 may apply the TCI state configuration to all CCs in the CC list. The communication manager 1506 may apply the TCI state configuration to CCs in another CC list of the one or more CC lists.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

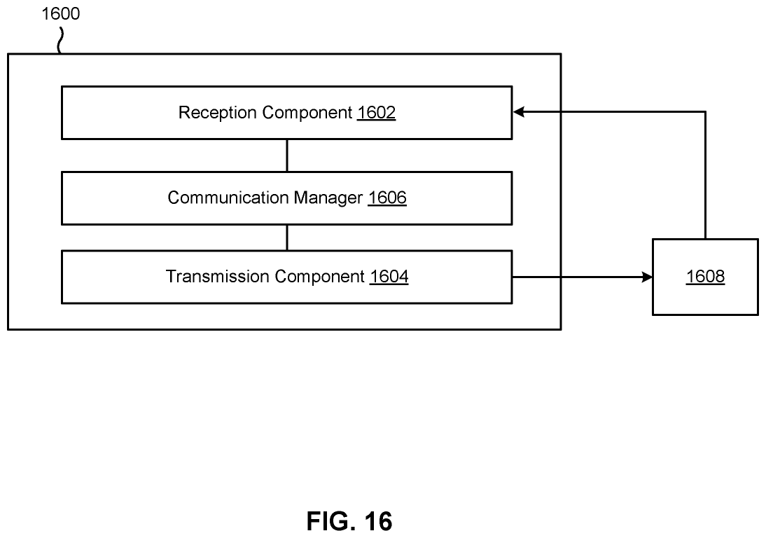

FIG. 16 is a diagram of an example apparatus 1600 for wireless communication, in accordance with the present disclosure. The apparatus 1600 may be a network entity (e.g., network node 110, network entity 510, network entity 610, network entity 910, network entity 1010), or a network entity may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 150 described in connection with FIG. 1. As shown, the apparatus 1600 may communicate with another apparatus 1608, such as a UE or a network node (such as a CU, a DU, an RU, or a base station), using the reception component 1602 and the transmission component 1604.

In some aspects, the apparatus 1600 may be configured to perform one or more operations described herein in connection with FIGS. 1-10. Additionally, or alternatively, the apparatus 1600 may be configured to perform one or more processes described herein from a viewpoint of the network entity. In some aspects, the apparatus 1600 and/or one or more components shown in FIG. 16 may include one or more components of the network entity described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the network entity described in connection with FIG. 2.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, a modem, a modulator, a transmit MIMO processor, a transmit processor, a controller/processor, a memory, or a combination thereof, of the network entity described in connection with FIG. 2. In some aspects, the transmission component 1604 may be co-located with the reception component 1602 in a transceiver.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

In some aspects, the transmission component 1604 may transmit a CC configuration for one or more CC lists that each include at least one TRP CC and at least one sTRP CC. The transmission component 1604 may transmit a TCI state configuration for a CC in a CC list of the one or more CC lists.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a user equipment (UE), comprising: receiving a physical downlink control channel (PDCCH) order downlink control information (DCI) that is for transmission of a physical random access channel (PRACH) message to a candidate cell; and transmitting the PRACH message with a transmit power that is based at least in part on whether the PDCCH order DCI applies to an initial transmission or a retransmission.

Aspect 2: The method of Aspect 1, wherein the PDCCH order DCI includes a bit or value that indicates whether the PDCCH order DCI applies to an initial transmission or a retransmission.

Aspect 3: The method of any of Aspects 1-2, wherein the transmit power is set for a retransmission based at least in part on the PDCCH order DCI being received within a time window associated with a previous PDCCH order DCI, or set for an initial transmission based at least in part on the PDCCH order DCI being received outside of the time window.

Aspect 4: The method of Aspect 3, wherein a start of the time window is based at least in part on a previous PRACH message transmission time scheduled by the previous PDCCH order DCI.

Aspect 5: The method of Aspect 3, wherein a start of the time window is based at least in part on a reception time of the previous PDCCH order DCI.

Aspect 6: A method of wireless communication performed by a user equipment (UE), comprising: transmitting a random access channel (RACH) message to a candidate cell based at least in part on receiving a physical downlink control channel order downlink control information from a serving cell; selecting a beam to receive a random access response (RAR); and receiving the RAR using the beam.

Aspect 7: The method of Aspect 6, wherein selecting the beam includes selecting a beam that corresponds to a transmit beam used for a type 1 common search space control resource set.

Aspect 8: The method of any of Aspects 6-7, wherein selecting the beam includes selecting a beam that corresponds to a transmit beam used for a physical downlink control channel order downlink control information.

Aspect 9: The method of any of Aspects 6-8, wherein selecting the beam includes selecting a default beam.

Aspect 10: The method of any of Aspects 6-9, wherein selecting the beam includes selecting a beam that corresponds to a beam used for a downlink reference signal associated with a physical random access channel message.

Aspect 11: The method of any of Aspects 6-10, further comprising determining a scrambling sequence used to decode the RAR based at least in part on whether the RAR is from a serving cell or a candidate cell.

Aspect 12: The method of Aspect 11, wherein determining the scrambling sequence includes determining the scrambling sequence based at least in part on a format of the RAR that is specific to layer 1 or layer 2 triggered mobility (LTM).

Aspect 13: The method of Aspect 11, further comprising reserving a random access channel occasion.

Aspect 14: The method of Aspect 11, wherein determining the scrambling sequence includes determining the scrambling sequence based at least in part on a random access channel occasion for a candidate cell.

Aspect 15: The method of any of Aspects 6-14, further comprising determining a timing advance value based at least in part on the RAR being included in a medium access control control element (MAC CE) with an RAR sub-header format that is specific to layer 1 or layer 2 triggered mobility.

Aspect 16: The method of any of Aspects 6-15, further comprising
determining a timing advance value based at least in part on the RAR being included in a medium access control control element (MAC CE) with a bit or value that is specific to layer 1 or layer 2 triggered mobility.

Aspect 17: The method of any of Aspects 6-16, further comprising determining whether to provide feedback for the RAR.

Aspect 18: The method of any of Aspects 6-17, wherein a gap time between a physical random access channel (PRACH) message and the RAR is based at least in part on whether the PRACH message is for layer 1 or layer 2 triggered mobility.

Aspect 19: A method of wireless communication performed by a user equipment (UE), comprising: triggering a first random access channel (RACH) procedure for layer 1 or layer 2 triggered mobility (LTM); triggering a second RACH procedure; and transmitting a physical RACH (PRACH) message for the first RACH procedure or the second RACH procedure based at least in part on a prioritization rule or condition.

Aspect 20: The method of Aspect 19, wherein the prioritization rule or condition specifies that RACH procedures are to be prioritized based at least in part on a RACH procedure type.

Aspect 21: The method of any of Aspects 19-20, wherein the prioritization rule or condition specifies that RACH procedures are to be prioritized based at least in part on whether a RACH procedure is for a serving cell or a candidate cell.

Aspect 22: The method of any of Aspects 19-21, wherein the prioritization rule or condition specifies that RACH procedures are to be prioritized based at least in part on a RACH procedure triggering time.

Aspect 23: The method of any of Aspects 19-22, wherein the prioritization rule or condition specifies that RACH procedures are to be prioritized based at least in part on a candidate cell identifier.

Aspect 24: A method of wireless communication performed by a user equipment (UE), comprising: receiving a component carrier (CC) configuration for one or more CC lists that each include at least one multiple transmit receive point (mTRP) CC and at least one single TRP (sTRP) CC; receiving a transmission configuration indicator (TCI) state configuration for a CC in a CC list of the one or more CC lists; and applying the TCI state configuration to all CCs in the CC list.

Aspect 25: The method of Aspect 24, wherein the TCI state configuration configures an mTRP CC as a reference CC, and wherein applying the TCI state configuration includes applying the TCI state configuration to sTRP CCs in the CC list.

Aspect 26: The method of any of Aspects 24-25, wherein the TCI state configuration configures an sTRP CC as a reference CC, and wherein applying the TCI state configuration includes applying the TCI state configuration to mTRP CCs in the CC list.

Aspect 27: The method of any of Aspects 24-26, further comprising applying the TCI state configuration to CCs in another CC list of the one or more CC lists.

Aspect 28: A method of wireless communication performed by a network entity, comprising: transmitting a component carrier (CC) configuration for one or more CC lists that each include at least one multiple transmit receive point (mTRP) CC and at least one single TRP (sTRP) CC; receiving a transmission configuration indicator (TCI) state configuration for a CC in a CC list of the one or more CC lists; and applying the TCI state configuration to all CCs in the CC list.

Aspect 29: An apparatus for wireless communication at a device, comprising a processor; memory coupled with the processor; and instructions stored in the memory and executable by the processor to cause the apparatus to perform the method of one or more of Aspects 1-28.

Aspect 30: A device for wireless communication, comprising a memory and one or more processors coupled to the memory, the one or more processors configured to perform the method of one or more of Aspects 1-28.

Aspect 31: An apparatus for wireless communication, comprising at least one means for performing the method of one or more of Aspects 1-28.

Aspect 32: A non-transitory computer-readable medium storing code for wireless communication, the code comprising instructions executable by a processor to perform the method of one or more of Aspects 1-28.

Aspect 33: A non-transitory computer-readable medium storing a set of instructions for wireless communication, the set of instructions comprising one or more instructions that, when executed by one or more processors of a device, cause the device to perform the method of one or more of Aspects 1-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
memory; and
one or more processors, coupled to the memory, configured to:
receive a physical downlink control channel (PDCCH) order downlink control information (DCI) that is for transmission of a physical random access channel (PRACH) message to a candidate cell; and
transmit the PRACH message with a transmit power that is based at least in part on whether the PDCCH order DCI applies to an initial transmission or a retransmission.

2. The UE of claim 1, wherein the PDCCH order DCI includes a bit or value that indicates whether the PDCCH order DCI applies to an initial transmission or a retransmission.

3. The UE of claim 1, wherein the transmit power is set for a retransmission based at least in part on the PDCCH order DCI being received within a time window associated with a previous PDCCH order DCI, or set for an initial transmission based at least in part on the PDCCH order DCI being received outside of the time window.

4. The UE of claim 3, wherein a start of the time window is based at least in part on a previous PRACH message transmission time scheduled by the previous PDCCH order DCI.

5. The UE of claim 3, wherein a start of the time window is based at least in part on a reception time of the previous PDCCH order DCI.

6. A user equipment (UE) for wireless communication, comprising:
memory; and
one or more processors, coupled to the memory, configured to:
transmit a random access channel (RACH) message to a candidate cell based at least in part on receiving a physical downlink control channel order downlink control information from a serving cell;
select a beam to receive a random access response (RAR); and
receive the RAR using the beam.

7. The UE of claim 6, wherein the one or more processors, to select the beam, are configured to select a beam that corresponds to a transmit beam used for a type 1 common search space control resource set.

8. The UE of claim 6, wherein the one or more processors, to select the beam, are configured to select a beam that corresponds to a transmit beam used for a physical downlink control channel order downlink control information.

9. The UE of claim 6, wherein the one or more processors, to select the beam, are configured to select a default beam.

10. The UE of claim 6, wherein the one or more processors, to select the beam, are configured to select a beam that corresponds to a beam used for a downlink reference signal associated with a physical random access channel message.

11. The UE of claim 6, wherein the one or more processors are configured to determine a scrambling sequence used to decode the RAR based at least in part on whether the RAR is from a serving cell or a candidate cell.

12. The UE of claim 6, wherein the one or more processors are configured to determine a timing advance value based at least in part on the RAR being included in a medium access control control element (MAC CE) with an RAR sub-header format that is specific to layer 1 or layer 2 triggered mobility or based at least in part on the RAR being included in a MAC CE with a bit or value that is specific to layer 1 or layer 2 triggered mobility.

13. The UE of claim 6, wherein the one or more processors are configured to determine whether to provide feedback for the RAR.

14. The UE of claim 6, wherein a gap time between a physical random access channel (PRACH) message and the RAR is based at least in part on whether the PRACH message is for layer 1 or layer 2 triggered mobility.

15. A user equipment (UE) for wireless communication, comprising:
memory; and
one or more processors, coupled to the memory, configured to:
trigger a first random access channel (RACH) procedure for layer 1 or layer 2 triggered mobility (LTM);
trigger a second RACH procedure; and
transmit a physical RACH (PRACH) message for the first RACH procedure or the second RACH procedure based at least in part on a prioritization rule or condition.

16. The UE of claim 15, wherein the prioritization rule or condition specifies that RACH procedures are to be one or more of:
prioritized based at least in part on a RACH procedure type,
prioritized based at least in part on whether a RACH procedure is for a serving cell or a candidate cell,
prioritized based at least in part on a RACH procedure triggering time, or
prioritized based at least in part on a candidate cell identifier.

17. A user equipment (UE) for wireless communication, comprising:
a memory; and
one or more processors, coupled to the memory, configured to:
receive a component carrier (CC) configuration for one or more CC lists that each include at least one multiple transmit receive point (mTRP) CC and at least one single TRP (sTRP) CC;
receive a transmission configuration indicator (TCI) state configuration for a CC in a CC list of the one or more CC lists; and
apply the TCI state configuration to all CCs in the CC list.

18. The UE of claim 17, wherein the TCI state configuration configures an mTRP CC as a reference CC, and wherein the one or more processors, to apply the TCI state configuration, are configured to the TCI state configuration to sTRP CCs in the CC list.

19. The UE of claim 17, wherein the TCI state configuration configures an sTRP CC as a reference CC, and wherein the one or more processors, to apply the TCI state configuration, are configured to apply the TCI state configuration to mTRP CCs in the CC list.

20. The UE of claim 17, wherein the one or more processors are configured to apply the TCI state configuration to CCs in another CC list of the one or more CC lists.
